(19) United States
(12) Patent Application Publication
(10) Pub. No.: US 2010/0170257 A1
(43) Pub. Date: Jul. 8, 2010

(54) COOLING A ONE-PIECE CAN COMBUSTOR AND RELATED METHOD

(75) Inventors: Ronald J. CHILA, Greer, SC (US); Kevin W. McMahan, Greer, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 12/350,423

(22) Filed: Jan. 8, 2009

(51) Int. Cl. F02G 3/00

(52) U.S. Cl. 60/754

(57) ABSTRACT

A cooling arrangement for cooling a single-piece, combined combustor liner/transition piece substantially enclosed within a surrounding flow sleeve, with a cooling annulus radially between the flow sleeve and the single-piece combined combustor liner/transition piece, the cooling arrangement including a first plurality of impingement cooling holes in the flow sleeve, the plurality of impingement cooling holes having first diameters and arranged to direct cooling air onto designated areas of the single-piece, combined combustor liner/transition piece; and a second plurality of effusion cooling holes in the single-piece, combined combustor liner/transition piece having second diameters smaller than the first diameters, and located to cool by effusion other areas of the single-piece, combined combustor liner/transition piece.

### BACKGROUND OF THE INVENTION

This invention relates generally to turbine components and more particularly to cooling a gas turbine combustor.

Industrial gas turbine combustors are typically designed to include a plurality of discrete combustion chambers or “cans” in an array around the circumference of the turbine rotor. Conventionally, the walls of an industrial gas turbine can-type combustion chamber are formed from two major pieces: a cylindrical or cone-shaped sheet metal liner engaging the round head end of the combustor, and a sheet metal transition piece that transitions the hot gas flowpath from the round cross-section of the liner to an arc-shaped sector of the inlet to the turbine first stage. These two combustor components are joined together in end-to-end relationship by means of a flexible joint, which requires some portion of compressor discharge air to be consumed in cooling flow and leakage at the joint.

In commonly-owned U.S. Pat. No. 7,082,766, there is disclosed a can combustor that includes a duct extending from the combustor forward or head end directly to the turbine first-stage inlet, i.e., the prior combustor liner and transition piece are combined into a single duct. In an exemplary embodiment, the combined combustor liner/transition piece (also sometimes referred to herein as a “single-piece duct”) is jointless, and a flow sleeve surrounds the single-piece duct in substantially concentric relationship therewith, creating a flow annulus therebetween for feeding air to the combustor. Cooling is achieved by providing impingement cooling holes in the surrounding flow sleeve such that some of the compressor discharge air also flows radially through the impingement cooling holes into the annulus between the single-piece duct and the flow sleeve to thereby cool the duct by impingement and convection cooling.

Forced convection alone, however, may not effectively cool the single-piece duct. There may be regions which are left uncooled (i.e., hot spots), owing to pressure drop limitations and/or non-uniform distribution of cooling flow.

There remains a need, therefore, for more effective and efficient cooling techniques for a single-piece duct which combines the prior combustor liner and transition piece of a gas turbine combustor.

### BRIEF DESCRIPTION OF THE INVENTION

In accordance with the exemplary but nonlimiting embodiment described herein, this invention employs effusion cooling to cool regions of the combined combustor liner/transition piece where impingement cooling is deficient. Thus, in one aspect, the present invention relates to a cooling arrangement for cooling a single-piece, combined combustor liner/transition piece substantially enclosed within a surrounding flow sleeve, with a cooling annulus radially between the flow sleeve and the single-piece, combined combustor liner/transition piece, the cooling arrangement comprising: a first plurality of impingement cooling holes in the impingement flow sleeve, the plurality of impingement cooling holes having first diameters and arranged to direct cooling air onto designated areas of the single-piece, combined combustor liner/transition piece; and a second plurality of effusion cooling holes in the single-piece, combined combustor liner/transition piece having second diameters smaller than the first diameters, and located to cool by effusion other areas of the single-piece, combined combustor liner/transition piece.

In another aspect, the invention relates to a method of cooling a single-piece, combined gas turbine combustor liner/transition piece comprising: (a) surrounding the single-piece, combined gas turbine combustor liner/transition piece with a flow sleeve, thereby establishing an annular flow passage between the single-piece, combined gas turbine combustor liner/transition piece and the flow sleeve; (b) providing a plurality of impingement cooling holes in the flow sleeve adapted to supply cooling air onto designated areas of the single-piece, combined gas turbine combustor liner/transition piece; and (c) providing a plurality of effusion cooling holes in the single-piece, combined gas turbine combustor liner/transition piece adapted to supply cooling air to other designated areas of the single-piece, combined gas turbine combustor liner/transition piece.

The invention will now be described in detail in connection with the drawings identified below.

### BRIEF DESCRIPTION OF THE DRAWINGS

FIG. 1 is a schematic representation of a single-piece combined combustor liner/transition piece surrounded by a flow sleeve in accordance with a known configuration; and

FIG. 2 is a partial perspective view of a single-piece combined combustor liner/transition piece provided with effusion cooling holes in accordance with an exemplary embodiment of the invention; and

FIG. 3 is a schematic cross-section illustrating a cooling flow pattern in the effusion-cooled area of the single-piece combined combustor liner/transition piece illustrated in FIG. 2.

### DETAILED DESCRIPTION OF THE INVENTION

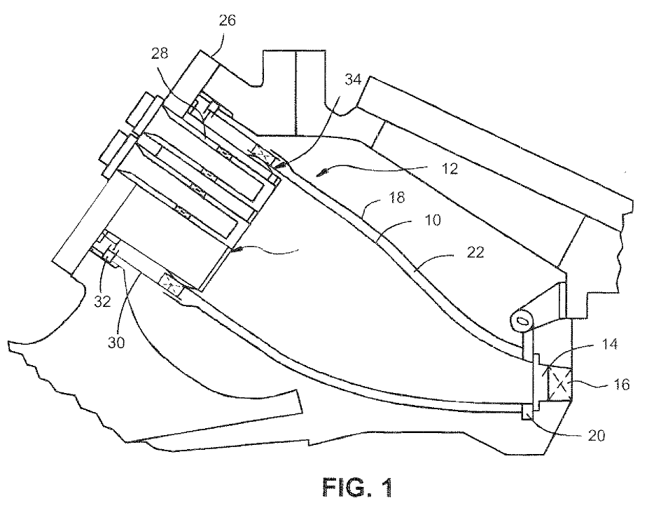

Referring to FIG. 1, an exemplary but nonlimiting embodiment of the invention includes a compound-shaped, cylindrical, single-piece, combined combustor liner/transition piece (or single-piece duct) 10 which extends directly from a circular combustor head-end 12 to a generally rectangular but arcuate sector 14 connected to the first stage of the turbine 16. The single-piece duct 10 may be formed from two halves or several components welded or joined together for ease of assembly or manufacture. Likewise, a single-piece flow sleeve 18 transitions directly from the circular combustor head-end. 12 to the aft frame 20. The single-piece flow sleeve 18 may also be formed from two halves and welded or joined together for ease of assembly. The joint between the flow sleeve 18 and the aft frame 20 forms a substantially closed end to a cooling annulus 22 located radially between the flow sleeve 18 and the single-piece duct 10.

Additional gas turbine combustor components, similar to those employed in the prior art, include a circular cap 24, and an end cover 26 supporting a plurality of fuel nozzles 28. The single-piece duct 10 also supports a forward sleeve 30 that may be fixedly attached to the single-piece duct 10 through radial struts 32 by e.g., welding.

At its forward end, the single-piece duct 10 is supported by a conventional hula seal 34 attached to the cap 24, radially between the cap and the duct 10. While the above described exemplary embodiment represents one solution, there are other conceivable configurations that would preserve the intent of a one-piece can combustor. For example, the hula seal 34 could be inverted and attached to the duct 10. In another example, the forward sleeve 30 is optionally made integral with the duct 10 by e.g., casting or other suitable manufacturing process.

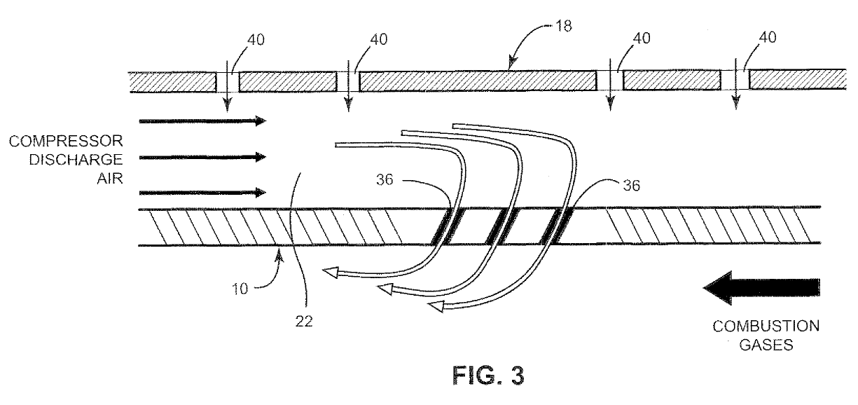

In use, compressor discharge air flows into and along the cooling annulus 22, formed by the flow sleeve 18 surrounding the single-piece duct 10, by means of impingement cooling holes, slots, or other openings (see impingement holes 40 in FIG. 3), formed in the flow sleeve, and that allow some portion of the compressor discharge air to flow radially through the holes to impinge upon and thus cool the single-piece duct 10 and to then flow along the annulus 22 to the forward end of the combustor where the air is reverse-flowed into the combustion chamber.

The impingement holes may be arranged in various patterns, for example, in axially spaced, aligned or offset annular rows, etc. or even in a random array.

Because of the typical large pitch spacing between adjacent impingement hole cooling jets, however, cooling of the single-piece duct 10 may be less than optimal. To supplement and enhance the impingement cooling, effusion cooling apertures 36 have been added to the single-piece duct 10. More specifically, one or more arrays 38 of effusion cooling apertures 36 are formed in selected locations about the single-piece duct 10 where impingement cooling in insufficient.

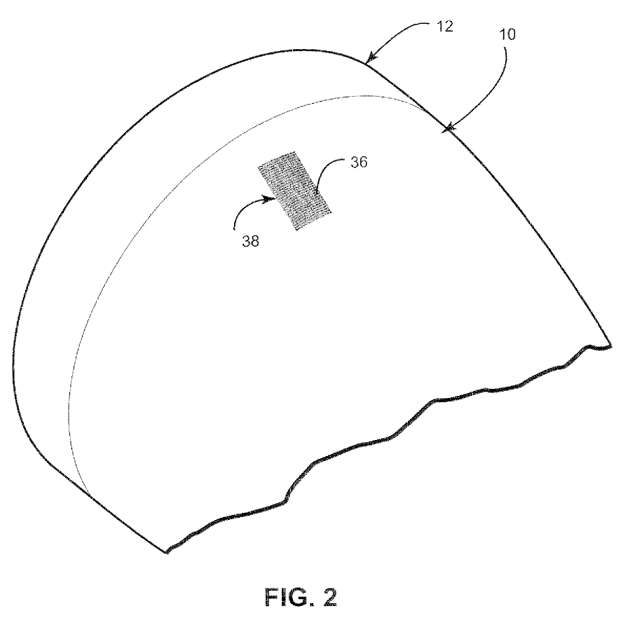

As shown in FIGS. 2, for example, an ordered array 38 of effusion cooling apertures 36 is located nearer the forward or head end 12 of the duct 10 and proximate the location of the hula seal, at least some of the apertures 36 located between adjacent, axially spaced rows of impingement cooling holes 40. The array 38 may be in the form of continuous or discontinuous patterns of apertures about the circumference of the duct 10, and there may be similar or different arrays axially between each adjacent pairs of rows of impingement holes 40, or in any other space not adequately cooled by jets of air flowing through the impingement cooling holes 40. The array pattern, i.e., rectangular, square, irregular, etc. may be determined by cooling requirements. In this way, high temperatures (i.e., hot spots) in those areas where impingement cooling is insufficient, can be alleviated while also minimizing thermal gradients. More specifically, as indicated by the flow arrows in FIG. 3, cooling air flowing along and through the annular passage 22, substantially perpendicular to the impingement jets entering the passage 22 via impingement holes 40, will flow through the effusion apertures 36 and establish a film of cooling air along the inside surface of the duct 10, thus enhancing the cooling of the duct, particularly in areas insufficiently cooled by impingement cooling. If desired, the effusion holes 36 may be angled to direct the effusion cooling air in the direction of flow of combustion gases in the liner.

In an exemplary but nonlimiting implementation, the impingement holes 40 may have diameters in the range of from about 0.10 to about 1.0 in. (or if noncircular, substantially equivalent cross-sectional areas). The smaller effusion holes 36 may have diameters in the range of from about 0.02 to about 0.04 in. (or if noncircular, substantially equivalent cross-sectional areas).

The combination of impingement and effusion cooling may be applied to any component where impingement jet pitch spacing yields unfavorable thermal conditions.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A cooling arrangement for cooling a single-piece, combined combustor liner/transition piece substantially enclosed within a surrounding flow sleeve, with a cooling annulus radially between said flow sleeve and said single-piece, combined combustor liner/transition piece, the cooling arrangement comprising:
a first plurality of impingement cooling holes in said flow sleeve, said plurality of impingement cooling holes having first diameters and arranged to direct cooling air onto designated areas of said single-piece, combined combustor liner/transition piece; and
a second plurality of effusion cooling holes in said single-piece, combined combustor liner/transition piece having second diameters smaller than said first diameters, and located to cool by effusion other areas of said single-piece, combined combustor liner/transition piece.

2. The cooling arrangement of claim 1 wherein said second plurality of effusion cooling holes are arranged in said single-piece, combined combustor liner/transition piece in at least one area offset from said first plurality of impingement cooling holes.

3. The cooling arrangement of claim 1 wherein said second plurality of effusion cooling holes are angled to direct effusion cooling air in a direction of flow of combustion gases in said single-piece, combined combustor liner/transition piece.

4. The cooling arrangement of claim 2 wherein said second plurality of effusion cooling holes are angled to direct effusion cooling air in a direction of flow of combustion gases in said single-piece, combined combustor liner/transition piece.

5. The cooling arrangement of claim 3 wherein said first plurality of impingement holes have diameters in a range of from about 0.10 to about 1.0 in. and said second plurality of effusion holes have diameters in a range of from about 0.02 to about 0.04 in.

6. A method of cooling a single-piece, combined gas turbine combustor liner/transition piece comprising:
(a) surrounding said single-piece, combined gas turbine combustor liner/transition piece with a flow sleeve, thereby establishing an annular flow passage between said single-piece, combined gas turbine combustor liner/transition piece and said flow sleeve;
(b) providing a plurality of impingement cooling holes in said flow sleeve adapted to supply cooling air onto designated areas of said single-piece, combined gas turbine combustor liner/transition piece; and
(c) providing a plurality of effusion cooling holes in said single-piece, combined gas turbine combustor liner/transition piece adapted to supply cooling air to other designated areas of said single-piece, combined gas turbine combustor liner/transition piece.

7. The method of claim 6 comprising arranging said plurality of effusion cooling holes in an ordered array in said single-piece, combined gas turbine combustor liner/transition piece in at least one area offset from said plurality of impingement cooling holes.

8. The method of claim 7 comprising angling said plurality of effusion cooling holes to direct effusion cooling air in a direction of flow of combustion gases in said single-piece, combined gas turbine combustor liner/transition piece.

9. The method of claim 6 wherein said plurality of impingement cooling holes have a specified cross-sectional area, and wherein said plurality of effusion cooling holes have cross-sectional areas relatively smaller than said plurality of impingement holes.

10. The method of claim 6 wherein said plurality of impingement cooling holes are round, each defined by a specified cross-sectional area, and wherein said plurality of effusion cooling holes are round and have cross-sectional areas relatively smaller than said plurality of impingement holes.

11. The method of claim 10 wherein said plurality of impingement holes have diameters in a range of from about 0.10 to about 1.0 in. and said plurality of effusion holes have diameters in a range of from about 0.02 to about 0.04 in.
